(19) United States
(12) Patent Application Publication
(10) Pub. No.: US 2025/0321107 A1
(43) Pub. Date: Oct. 16, 2025

(54) SYSTEMS AND METHODS FOR REAL-TIME VEHICLE ROUTE DERIVATION AND PREDICTION

(71) Applicant: Toyota Jidosha Kabushiki Kaisha, Aichi-ken (JP)

(72) Inventor: Emily Lerner, Ypsilanti, MI (US)

(73) Assignee: Toyota Jidosha Kabushiki Kaisha, Aichi-ken (JP)

(21) Appl. No.: 18/631,802

(22) Filed: Apr. 10, 2024

(51) Int. Cl. G01C 21/34

(52) U.S. Cl. CPC G01C 21/3407

(57) ABSTRACT

A vehicle route system includes a processor and a non-transitory, processor-readable storage medium communicatively coupled to the processor and including one or more instructions stored thereon that, when executed, cause the processor to obtain a first vehicle route for a vehicle, the first vehicle route comprising a predetermined route to a destination by the vehicle; compare a second vehicle route undertaken by the vehicle with the first vehicle route; determine, based on comparing, one or more changes between the first and second vehicle routes, the one or more changes including a vehicle maneuver on the second vehicle route that deviates from a road segment along the first vehicle route; classify whether the one or more changes fall into a first category selected from a plurality of categories, the first category comprising a physical infrastructure category; and determine a confidence value based on the classification of the one or more changes.

### FIELD

The present disclosure generally relates to devices for vehicle route derivation, and more particularly, to real-time vehicle route derivation and prediction.

### BACKGROUND

Navigation applications monitor driving data to support providing navigation routes to drivers. This data is aggregated such that data for a segment, such as a defined subdivision of a road, can be used to infer conditions across that segment. Further, the navigation applications also solicit direct user feedback to know the current conditions of the road. However, this data looks at traffic patterns in the aggregate and does not provide insight on trends that can indicate changes in routes and patterns of route changes over a region. These and other deficiencies exist.

### BRIEF DESCRIPTION OF THE DRAWINGS

In one aspect, a vehicle route system may include a processor, and a non-transitory, processor-readable storage medium communicatively coupled to the processor, the non-transitory, processor-readable storage medium comprising one or more instructions stored thereon that, when executed, cause the processor to: obtain a first vehicle route for a vehicle, the first vehicle route comprising a predetermined route to a destination by the vehicle; compare a second vehicle route undertaken by the vehicle with the first vehicle route; determine, based on the comparison, one or more changes between the first vehicle route and the second vehicle route, the one or more changes including a vehicle maneuver on the second vehicle route that deviates from a road segment along the first vehicle route; classify whether the one or more changes fall into a first category selected from a plurality of categories, the first category comprising a physical infrastructure category; and determine a confidence value based on the classification of the one or more changes.

In another aspect, a method may include obtaining a first vehicle route for a vehicle, the first vehicle route comprising a predetermined route to a destination by the vehicle. The method may include comparing a second vehicle route undertaken by the vehicle with the first vehicle route. The method may include determining, based on the comparison, one or more changes between the first vehicle route and the second vehicle route, the one or more changes including a vehicle maneuver on the second vehicle route that deviates from a road segment along the first vehicle route. The method may include classifying whether the one or more changes fall into a first category selected from a plurality of categories, the first category comprising a physical infrastructure category. The method may include determining a confidence value based on the classification of the one or more changes.

In another aspect, a non-transitory, computer-readable medium including instructions that, when executed by at least one processor, cause the at least one processor to perform one or more operations including obtaining a first vehicle route for a vehicle, the first vehicle route comprising a predetermined route to a destination by the vehicle; comparing a second vehicle route undertaken by the vehicle with the first vehicle route; determining, based on the comparison, one or more changes between the first vehicle route and the second vehicle route, the one or more changes including a vehicle maneuver on the second vehicle route that deviates from a road segment along the first vehicle route; classifying whether the one or more changes fall into a first category selected from a plurality of categories, the first category comprising a physical infrastructure category; and determining a confidence value based on the classification of the one or more changes.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of ‘a’, ‘an’, and ‘the’ include plural referents unless the context clearly dictates otherwise.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, wherein like structure is indicated with like reference numerals and in which:

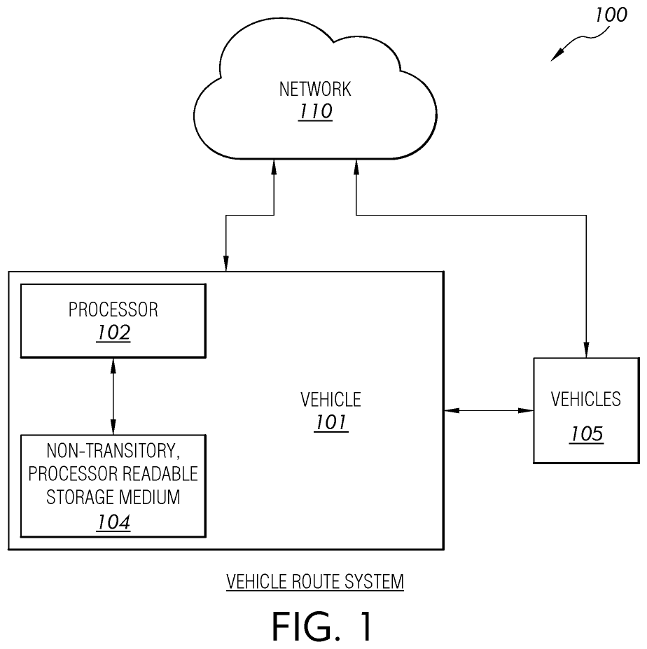

FIG. 1 depicts a schematic diagram of an example vehicle route system, according to one or more embodiments shown and described herein; and

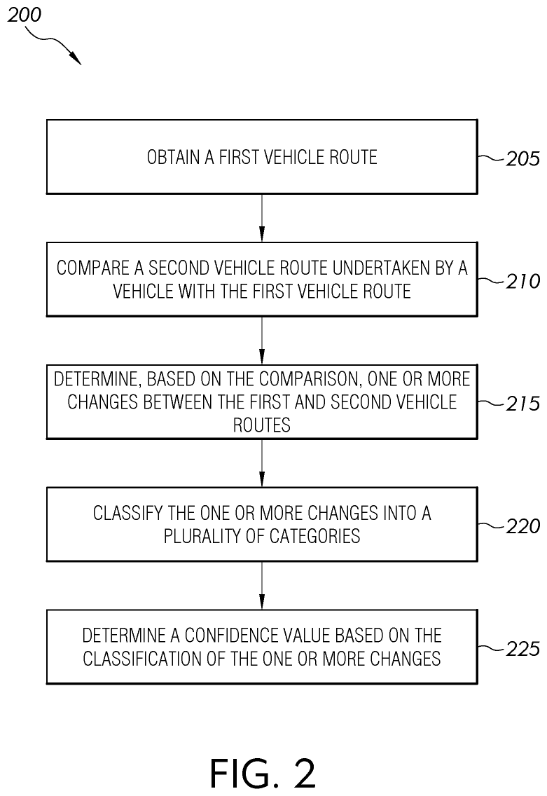

FIG. 2 depicts a flow diagram of an example method to be performed by a processor, according to one or more embodiments shown and described herein.

### DETAILED DESCRIPTION

The systems and methods disclosed herein improves detection of route information that includes both planned and unplanned infrastructure changes based on changes in driving patterns of vehicles. Road networks frequently change, which not only impacts budget allocation but also map freshness that should be kept up to date. In such instances, it is beneficial to identify the rate of change of a given location as compared to another location. By having vehicles visiting these and other locations on a more frequent basis, there is an increased likelihood of keeping up-to-date maps that are accurate while also building confidence in not only maps for drivers, but also for autonomous vehicles that are configured to accurately and safely navigate to a destination through an accurate route. In this manner, the systems and methods disclosed herein are configured to improve the detection, in real-time, of changes of a given route, and navigation thereto, over a given time period based on changes in both infrastructure and driver patterns. Therefore, the systems and methods disclosed herein may be configured to also solve the problem of map freshness, and improving confidence in autonomous driving vehicles, as well as non-autonomous driving vehicles, to make decisions in driving transition demands.

FIG. 1 depicts a schematic diagram of an example vehicle route system 100. As illustrated in FIG. 1, the vehicle route system 100 includes a vehicle 101, a processor 102, a non-transitory processor readable storage medium 104, vehicles 105, and a network 110. Although FIG. 1 illustrates single instances of the constituent components of the vehicle route system 100, the vehicle route system 100 may include any number of constituent components.

In certain embodiments, the vehicle 101 may include an autonomous driving vehicle. In other embodiments, the vehicle 101 may include a vehicle that is not an autonomous driving vehicle. Without limitation, the vehicle 101 may include a passenger vehicle, a non-passenger vehicle, a taxi, a bus, a scooter, a motorcycle, a truck, or any other type of vehicle.

The processor 102, such as a central processing unit (CPU), may be the central processing unit that is configured to perform calculations and logic operations to execute one or more programs. The processor 102, alone or in conjunction with the other components, may be an illustrative processing device, computing device, processor, or combinations thereof, including, for example, a multi-core processor, a microcontroller, a field-programmable gate array (FPGA), or an application-specific integrated circuit (ASIC). The processor 102 may include any processing component configured to receive and execute instructions (such as from the non-transitory processor readable storage medium 104).

In some examples, the processing device may execute one or more applications, such as software applications, that enable, for example, network communications with one or more components of the vehicle route system 100 and transmit and/or receive data.

The non-transitory processor readable storage medium 104 may contain one or more data repositories for storing data that is received and/or generated. The non-transitory processor readable storage medium 104 may be any physical storage medium, including, but not limited to, a hard disk drive (HDD), memory (e.g., read-only memory (ROM), programmable read-only memory (PROM), random access memory (RAM), double data rate (DDR) RAM, flash memory, and/or the like), removable storage, a configuration file (e.g., text) and/or the like. While the non-transitory processor readable storage medium 104 is depicted as a local device, it should be understood that the non-transitory processor readable storage medium 104 may be a remote storage device, such as, for example, a server computing device, cloud-based storage device, or the like.

The vehicles 105 may be additional to vehicle 101, and may each be configured to include the same constituent components of vehicle 101. Similarly, the vehicles 105 may, in certain embodiments, include an autonomous driving vehicle. In certain embodiments, the vehicles 105 may not include an autonomous driving vehicle.

The network 110 may be one or more of a wireless network, a wired network, or any combination of wireless network and wired network, and may be configured to operably communicate with any and all of the constituent components of the vehicle route system 100. For example, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like. In addition, the network 110 may include, without limitation, telephone lines, fiber optics, IEEE Ethernet 802.3, a wide area network, a wireless personal area network, a LAN, or a global network such as the Internet. In addition, the network 110 may support an Internet network, a wireless communication network, a cellular network, or the like, or any combination thereof. The network 110 may further include one network, or any number of the exemplary types of networks mentioned above, operating as a stand-alone network or in cooperation with each other. The network 110 may utilize one or more protocols of one or more network elements to which they are communicatively coupled. The network 110 may translate to or from other protocols to one or more protocols of network devices. Although the network 110 is depicted as a single network, it should be appreciated that in one or more aspects, the network 110 may include a plurality of interconnected networks, such as, for example, the Internet, a service provider's network, a cable television network, corporate networks, such as credit card association networks, and home networks.

The processor 102 may be configured to obtain a first vehicle route for a vehicle 101. In certain embodiments, the first vehicle route may include a predetermined route to a destination by the vehicle 101. The processor 102 may be configured to compare a second vehicle route undertaken by the vehicle 101 with the first vehicle route. Based on the comparison, the processor 102 may be configured to determine one or more changes between the first vehicle route and the second vehicle route. In certain embodiments, the one or more changes includes a vehicle maneuver, relative to the vehicle 101, on the second vehicle route that deviates from a road segment along the first vehicle route.

The processor 102 may be configured to classify whether the one or more changes fall into a first category selected from a plurality of categories. In certain embodiments, the first category includes a physical infrastructure category. By way of example, the physical infrastructure category includes a bridge, a ramp, a link, a lane, or any combination thereof. The processor 102 may be configured to classify whether the one or more changes fall into a second category selected from a plurality of categories. In certain embodiments, the second category includes a non-physical infrastructure category. By way of example, the non-physical infrastructure category includes a speed limit change, a perceived change in road safety, road conditions, or any combination thereof.

The processor 102 may be configured to determine a confidence value based on the classification of the one or more changes. Further, in certain embodiments, the processor 102 may be configured to display, on a map, including the first vehicle route and the second vehicle route. The processor 102 may be configured to update the map to display the one or more changes.

The processor 102 may be configured to assign one or more rankings to a respective region on a map based on the one or more changes. The processor 102 may be configured to assign rankings for various regions on a map based on one or more comparisons. For example, the processor 102 may be configured to assign numerical and/or character rankings for the various regions on the map. In certain embodiments, the processor 102 may be configured to perform the one or more comparisons based on historical map data and changes made to road network links over a predetermined time period. These changes may reflect changes to physical infrastructure and driving patterns, as further explained below.

In certain embodiments, the one or more changes may reflect changes to physical infrastructure. By way of example and without limitation, the one or more changes to the physical infrastructure may include changes to bridges, ramps, links, lanes, highways, structures, drainage, or any combination thereof.

In certain embodiments, the one or more changes may also reflect changes in driving patterns that are indicative of conditions that are not directly related to changes in the physical infrastructure. By way of example and without limitation, the one or more changes not directly related to changes in the physical infrastructure, such as non-physical infrastructure, may include actual or customary speed limit changes, perceived changes in road safety, perfection of a route, road conditions, or any combination thereof.

To derive the one or more changes, the processor 102 may be configured to analyze patterns of drivers of vehicles 105 individually and aggregately. The processor 102 may be configured to establish the patterns of driving for a driver for a given vehicle 101. In certain embodiments, the processor 102 may also be configured to establish patterns of driving for one or more additional drivers for a respective vehicle 101, 105. In certain embodiments, a driver may tend to drive a predictable route established over time between two destinations. However, it is understood that such a tendency is not limited to two destinations, and that any number of destinations may be undertaken by the driver or vehicle 101 as part of its predictable route. In some examples, the route may be a heat map of segments that comprise the route between the two destinations. When the processor 102 is configured to detect a change of this route over time, the processor 102 may be configured to denote the segment that has changed. The processor 102 may be configured to aggregate these changes with others, and using this information, the processor 102 may be configured to: i) deduce segments that are no longer available; ii) identify a rate of change over an area by combining segment stores; iii) detect potential changes in infrastructure that are not directly related to planned changes; and iv) analyze long term effects of planned changes to the infrastructure.

Returning back to the assigned rankings, these rankings by the processor 102 may provide a holistic view of a region on the map. For example, the processor 102 may be configured to calculate a numerical ranking, such that a driver could know that a first location has a different rate of change factor over a given time period relative to a second location. By way of example, a driver could know that Los Angeles has a rate of change factor of X units per year on average as compared to Denver has a rate of change factor of Y units per year. In this example, a key factor would be average calculate over many years of map data. Further, the assigned rankings by the processor 102 may also provide an analysis of specific road segments, or groups of road segments, that indicate that a given road segment is used more. Additionally, the assigned rankings by the processor 102 may provide an analysis of the specific road segments, or groups of road segments, that indicate that a given segment has experienced a change that may indicate an issue with the segment, or the lack of availability of the segment of a road.

In certain embodiments, the processor 102 may be configured determine a change of a route. For example, while the vehicle 101 may have some awareness of a map, the vehicle 101 may be configured to understand when the driver deviates from what it thinks is an accurate map relative to route navigation. When the vehicle 101 is under the impression that there is a road to be driven based on a map, but the driver of the vehicle 101 but does not do so, or the vehicle 101 itself does not do so for an autonomous vehicle, the processor 102 may be configured to determine this type of change.

In certain embodiments, the processor 102 may be configured to determine the change of a route over a plurality of vehicles 105. For example, the processor 102 may be configured to detect the absence or presence of one or more predetermined parameters in determining whether a change of the route has taken place. Without limitation, regarding the one or more predetermined parameters, the processor 102 may be configured to determine the absence or presence of road signs for the route to a destination, the absence or presence of turn signaling for the route to the destination, or any combination thereof. This information may be obtained and accumulated and then validated over a large scale (of a plurality of vehicles 105 as well as over any number of predetermined time periods) to derive a confidence value, and also improve this value using one or more machine learning algorithms. In particular, the processor 102 may be configured to confirm whether there is a change of the route based on obtaining and analyzing the absence or presence of road signs and turn signaling relative to the route navigated to the destination.

By way of example, should the route to the destination indicate that a right turn is needed two hundred meters before a right turn, and one hundred vehicles 105 over a given time period are always turning left or going straight, i.e. not turning right, the processor 102 may be configured to establish a confidence value relative to making the right turn as instructed by the navigation. In such a case, the confidence value for making the right turn may be low whereas a confidence turn for turning left or going straight may be a greater value than that relative to the right turn. Further, the processor 102 may be configured to not only establish a confidence value relative to an indicated instruction, such as making the right turn, but also update this portion of the route to the destination. That is, the processor 102 may be configured to update the number of “no right turns”, and further infer that, during the route to the destination, an exit ramp has changed due to road infrastructure changes should the processor 102 determine that vehicles 105 were turning left or going straight at three hundred meters before the right turn when the navigation was instructing a right turn at two hundred meters.

By way of another example, the processor 102 may be configured to determine a change in the route by utilizing historic map information for any number of drivers. For example, the processor 102 may be configured to store historic map information for a driver pertaining to that driver entering a given highway at 9 am on certain weekdays, and that the driver has been undertaking this route to a destination for the past three years. This information may correspond, in certain embodiments, to historic map information for the driver or the vehicle 101. The processor 102 may be configured to recognize that, on one weekday, the driver of the vehicle 101 (or the vehicle 101, for an autonomous driving vehicle) is not undertaking this route despite arriving at the same destination. In particular, the processor 102 may be configured to determine that the driver is instead undertaking a service road. For example, the processor 102 may be configured to make this determination based on real-time coordinates identification of the vehicle 101. Based on the coordinates identified, along with obtained sensor data acquired through one or more on-board vehicle image acquisition devices, the processor 102 may be configured to determine the change in the route. The processor 102 may be configured to determine that the road may have changed due to, for example, infrastructure changes of the route to the destination.

By way of yet another example, the processor 102 may be configured to determine, via a heat map including thousands of drivers that drive over road links, a change relative to the road links. For example, the processor 102 may be configured to recognize that, on one day, those road links no longer turn left and thereby classify that such a change may be due to construction or alternatively a change in infrastructure. In making this recognition and classification regarding the change due to construction, the processor 102 may be configured to determine that the road link to turn left has not been traversed one day, or not traversed between the hours from 8 am to 5 pm. However, should another week or two go by (or some other predetermined time period), and more and more vehicles 105 are re-routing by not turning left, the processor 102 may be configured to determine that the road link to turn left is not due to construction but instead infrastructure due to obtaining city data to establish that a given infrastructure has prohibited turning left on the road link. In this manner, the processor 102 may be configured to establish and increase a confidence level in its determination that the route change is due to infrastructure and not construction because it is able to supplement its analysis with, for example, web scraping pertaining to news, road closures, and vehicle video data. For example, the processor 102 may be configured to obtain additional information from one or more additional data sources to supplement its classification of the one or more changes, the additional information from the one or more additional data sources comprising web scraping data related to the physical infrastructure category. It is understood that the web scraping data is not only relative to the physical infrastructure category but also the non-physical infrastructure category. The processor 102 may be configured to update, based on the additional information, the confidence value.

In certain embodiments, the processor 102 may be configured to confirm there is the change of the route prior to aggregating the changes. The change, or changes, may be recorded by the processor 102 and then classified as a particular type of change. For example, the particular type of change may be classified, by the processor 102, as a road sign, a building, where and when the change occurred, and a decision as to whether or not to geofence a change on the route on a map for a given city. All of these aggregated changes may be aggregated for a given location, such as for a city. For example, the processor 102 may be configured to determine that, in Los Angeles, there were one hundred sign changes in a given month, and then over time, the processor 102 may be configured to determine how that number fluctuates so as to obtain a baseline for a rate of change for this particular location. The processor 102 may be configured to aggregate the one or more changes for a plurality of vehicles 105 for a plurality of destinations over a predetermined time period. The processor 102 may be configured to classify whether the aggregated one or more changes fall into the first category or a second category selected from the plurality of categories. The processor 102 may be configured to display the location of the aggregated one or more changes on a map relative to the first vehicle route.

For example, while the map may suggest that drivers of respective vehicles 105 should be driving along a route to a given destination, but instead the processor 102 is configured to determine that the drivers are driving next to the route, such as along a road segment adjacent to a portion of the route or an entirely different route. In this manner, the processor 102 may be configured to determine a change of the route. As part of this change determination, the processor 102 may be configured to also detect road signs via one or more on-board vehicle image acquisition devices, such as one or more on-board cameras, and/or via Internet of Things (IoT). That is, after the processor 102 is configured to determine the change of the route, the processor 102 may be configured to determine the rate of change.

While the systems and methods disclosed herein are applicable to a vehicle 101 that is an autonomous driving vehicle, it is understood that vehicles 101, 105 that are not autonomous driving vehicles are also applicable. For example, the benefit of using a vehicle 101, 105 that is not an autonomous driving vehicle, including but not limited to a battery or hybrid vehicle, is that it uses route information to optimize battery economy and operational efficiency, which can impact range estimation for the vehicle 101, 105.

FIG. 2 depicts a flow diagram of an example method 200 performed by the processor 102. FIG. 2 may reference and incorporate any of the above constituent components and corresponding disclosure explained above with respect to FIG. 1, such as the example vehicle route system 100.

At block 205, the processor may be configured to obtain a first vehicle route for a vehicle. In certain embodiments, the first vehicle route may include a predetermined route to a destination by the vehicle.

At block 210, the processor may be configured to compare a second vehicle route undertaken by the vehicle with the first vehicle route.

At block 215, based on the comparison, the processor may be configured to determine one or more changes between the first vehicle route and the second vehicle route. In certain embodiments, the one or more changes includes a vehicle maneuver on the second vehicle route that deviates from a road segment along the first vehicle route.

At block 220, the processor may be configured to classify whether the one or more changes fall into a first category selected from a plurality of categories. In certain embodiments, the first category includes a physical infrastructure category. By way of example, the physical infrastructure category includes a bridge, a ramp, a link, a lane, or any combination thereof. The processor may be configured to classify whether the one or more changes fall into a second category selected from a plurality of categories. In certain embodiments, the second category includes a non-physical infrastructure category. By way of example, the non-physical infrastructure category includes a speed limit change, a perceived change in road safety, road conditions, or any combination thereof.

At block 225, the processor may be configured to determine a confidence value based on the classification of the one or more changes.

The processor may be configured to display, on a map, including the first vehicle route and the second vehicle route. The processor may be configured to update the map to display the one or more changes.

The processor may be configured to assign one or more rankings to a respective region on a map based on the one or more changes. The processor may be configured to assign rankings for various regions on a map based on one or more comparisons. For example, the processor may be configured to assign numerical and/or character rankings for the various regions on the map. In certain embodiments, the processor may be configured to perform the one or more comparisons based on historical map data and changes made to road network links over a predetermined time period. These changes may reflect changes to physical infrastructure and driving patterns, as further explained below.

In certain embodiments, the one or more changes may reflect changes to physical infrastructure. By way of example and without limitation, the one or more changes to the physical infrastructure may include changes to bridges, ramps, links, lanes, highways, structures, drainage, or any combination thereof.

In certain embodiments, the one or more changes may also reflect changes in driving patterns that are indicative of conditions that are not directly related to changes in the physical infrastructure. By way of example and without limitation, the one or more changes not directly related to changes in the physical infrastructure, such as non-physical infrastructure, may include actual or customary speed limit changes, perceived changes in road safety, perfection of a route, road conditions, or any combination thereof.

To derive the one or more changes, the processor may be configured to analyze patterns of drivers of vehicles individually and aggregately. The processor may be configured to establish the patterns of driving for a driver for a given vehicle. In certain embodiments, the processor may also be configured to establish patterns of driving for one or more additional drivers for a respective vehicle. In certain embodiments, a driver may tend to drive a predictable route established over time between two destinations. However, it is understood that such a tendency is not limited to two destinations, and that any number of destinations may be undertaken by the driver as part of its predictable route. In some examples, the route may be a heat map of segments that comprise the route between the two destinations. When the processor is configured to detect a change of this route over time, the processor may be configured to denote the segment that has changed. The processor may be configured to aggregate these changes with others, and using this information, the processor may be configured to: i) deduce segments that are no longer available; ii) identify a rate of change over an area by combining segment stores; iii) detect potential changes in infrastructure that are not directly related to planned changes; and iv) analyze long term effects of planned changes to the infrastructure.

Returning back to the assigned rankings, these rankings by the processor may provide a holistic view of a region on the map. For example, the processor may be configured to calculate a numerical ranking, such that a driver could know that a first location has a different rate of change factor over a given time period relative to a second location. By way of example, a driver could know that Los Angeles has a rate of change factor of X units per year on average as compared to Denver has a rate of change factor of Y units per year. In this example, a key factor would be average calculate over many years of map data. Further, the assigned rankings by the processor may also provide an analysis of specific road segments, or groups of road segments, that indicate that a given road segment is used more. Additionally, the assigned rankings by the processor may provide an analysis of the specific road segments, or groups of road segments, that indicate that a given segment has experienced a change that may indicate an issue with the segment, or the lack of availability of the segment of a road.

In certain embodiments, the processor may be configured determine a change of a route. For example, while the vehicle may have some awareness of a map, the vehicle may be configured to understand when the driver deviates from what it thinks is an accurate map relative to route navigation. When the vehicle is under the impression that there is a road to be driven based on a map, but the driver of the vehicle but does not do so, or the vehicle itself does not do so for an autonomous vehicle, the processor may be configured to determine this type of change.

In certain embodiments, the processor may be configured to determine the change of a route over a plurality of vehicles. For example, the processor may be configured to detect the absence or presence of one or more predetermined parameters in determining whether a change of the route has taken place. Without limitation, regarding the one or more predetermined parameters, the processor may be configured to determine the absence or presence of road signs for the route to a destination, the absence or presence of turn signaling for the route to the destination, or any combination thereof. This information may be obtained and accumulated and then validated over a large scale (of a plurality of vehicles as well as over any number of predetermined time periods) to derive a confidence value, and also improve this value using one or more machine learning algorithms. In particular, the processor may be configured to confirm whether there is a change of the route based on obtaining and analyzing the absence or presence of road signs and turn signaling relative to the route navigated to the destination.

By way of example, should the route to the destination indicate that a right turn is needed two hundred meters before a right turn, and one hundred vehicles over a given time period are always turning left or going straight, i.e. not turning right, the processor may be configured to establish a confidence value relative to making the right turn as instructed by the navigation. In such a case, the confidence value for making the right turn may be low whereas a confidence turn for turning left or going straight may be a greater value than that relative to the right turn. Further, the processor may be configured to not only establish a confidence value relative to an indicated instruction, such as making the right turn, but also update this portion of the route to the destination. That is, the processor may be configured to update the number of “no right turns”, and further infer that, during the route to the destination, an exit ramp has changed due to road infrastructure changes should the processor determine that vehicles were turning left or going straight at three hundred meters before the right turn when the navigation was instructing a right turn at two hundred meters.

By way of another example, the processor may be configured to determine a change in the route by utilizing historic map information for any number of drivers. For example, the processor may be configured to store historic map information for a driver pertaining to that driver entering a given highway at 9 am on certain weekdays, and that the driver has been undertaking this route to a destination for the past three years. This information may correspond, in certain embodiments, to historic map information for the driver or the vehicle. The processor may be configured to recognize that, on one weekday, the driver of the vehicle (or the vehicle, for an autonomous driving vehicle) is not undertaking this route despite arriving at the same destination. In particular, the processor may be configured to determine that the driver is instead undertaking a service road. For example, the processor may be configured to make this determination based on real-time coordinates identification of the vehicle. Based on the coordinates identified, along with obtained sensor data acquired through one or more on-board vehicle image acquisition devices, the processor may be configured to determine the change in the route. The processor may be configured to determine that the road may have changed due to, for example, infrastructure changes of the route to the destination.

By way of yet another example, the processor may be configured to determine, via a heat map including thousands of drivers that drive over road links, a change relative to the road links. For example, the processor may be configured to recognize that, on one day, those road links no longer turn left and thereby classify that such a change may be due to construction or alternatively a change in infrastructure. In making this recognition and classification regarding the change due to construction, the processor may be configured to determine that the road link to turn left has not been traversed one day, or not traversed between the hours from 8 am to 5 pm. However, should another week or two go by (or some other predetermined time period), and more and more vehicles are re-routing by not turning left, the processor may be configured to determine that the road link to turn left is not due to construction but instead infrastructure due to obtaining city data to establish that a given infrastructure has prohibited turning left on the road link. In this manner, the processor may be configured to establish and increase a confidence level in its determination that the route change is due to infrastructure and not construction because it is able to supplement its analysis with, for example, web scraping pertaining to news, road closures, and vehicle video data. For example, the processor may be configured to obtain additional information from one or more additional data sources to supplement its classification of the one or more changes, the additional information from the one or more additional data sources comprising web scraping data related to the physical infrastructure category. It is understood that the web scraping data is not only relative to the physical infrastructure category but also the non-physical infrastructure category. The processor may be configured to update, based on the additional information, the confidence value.

In certain embodiments, the processor may be configured to confirm there is the change of the route prior to aggregating the changes. The change, or changes, may be recorded by the processor and then classified as a particular type of change. For example, the particular type of change may be classified, by the processor, as a road sign, a building, where and when the change occurred, and a decision as to whether or not to geofence a change on the route on a map for a given city. All of these aggregated changes may be aggregated for a given location, such as for a city. For example, the processor may be configured to determine that, in Los Angeles, there were one hundred sign changes in a given month, and then over time, the processor may be configured to determine how that number fluctuates so as to obtain a baseline for a rate of change for this particular location. The processor may be configured to aggregate the one or more changes for a plurality of vehicles for a plurality of destinations over a predetermined time period. The processor may be configured to classify whether the aggregated one or more changes fall into the first category or a second category selected from the plurality of categories. The processor may be configured to display the location of the aggregated one or more changes on a map relative to the first vehicle route.

For example, while the map may suggest that drivers of respective vehicles should be driving along a route to a given destination, but instead the processor is configured to determine that the drivers are driving next to the route, such as along a road segment adjacent to a portion of the route or an entirely different route. In this manner, the processor may be configured to determine a change of the route. As part of this change determination, the processor may be configured to also detect road signs via one or more on-board vehicle image acquisition devices, such as one or more on-board cameras, and/or via Internet of Things (IoT). That is, after the processor is configured to determine the change of the route, the processor may be configured to determine the rate of change.

While the systems and methods disclosed herein are applicable to a vehicle that is an autonomous driving vehicle, it is understood that vehicles that are not autonomous driving vehicles are also applicable. For example, the benefit of using a vehicle that is not an autonomous driving vehicle, including but not limited to a battery or hybrid vehicle, is that it uses route information to optimize battery economy and operational efficiency, which can impact range estimation for the vehicle.

The systems and methods disclosed herein improves detection of route information that includes both planned and unplanned infrastructure changes based on changes in driving patterns of vehicles. Road networks frequently change, which not only impacts budget allocation but also map freshness that should be kept up to date. In such instances, it is beneficial to identify the rate of change of a given location as compared to another location. By having vehicles visiting these and other locations on a more frequent basis, there is an increased likelihood of keeping up-to-date maps that are accurate while also building confidence in not only maps for drivers, but also for autonomous vehicles that are configured to accurately and safely navigate to a destination through an accurate route. In this manner, the systems and methods disclosed herein are configured to improve the detection, in real-time, of changes of a given route, and navigation thereto, over a given time period based on changes in both infrastructure and driver patterns. Therefore, the systems and methods disclosed herein may be configured to also solve the problem of map freshness, and improving confidence in autonomous driving vehicles, as well as non-autonomous driving vehicles, to make decisions in driving transition demands.

Further aspects of the disclosure are provided by the subject matter of the following clauses.

A vehicle route system, comprising: a processor; and a non-transitory, processor-readable storage medium communicatively coupled to the processor, the non-transitory, processor-readable storage medium comprising one or more instructions stored thereon that, when executed, cause the processor to: obtain a first vehicle route for a vehicle, the first vehicle route comprising a predetermined route to a destination by the vehicle; compare a second vehicle route undertaken by the vehicle with the first vehicle route; determine, based on the comparison, one or more changes between the first vehicle route and the second vehicle route, the one or more changes including a vehicle maneuver on the second vehicle route that deviates from a road segment along the first vehicle route; classify whether the one or more changes fall into a first category selected from a plurality of categories, the first category comprising a physical infrastructure category; and determine a confidence value based on the classification of the one or more changes.

The vehicle route system of the previous clause, wherein the physical infrastructure category comprises a bridge, a ramp, a link, a lane, or any combination thereof.

The vehicle route system of any of the previous clauses, wherein the processor is further configured to classify whether the one or more changes fall into a second category selected from a plurality of categories, the second category comprising a non-physical infrastructure category.

The vehicle route system of the previous clause, wherein the non-physical infrastructure category comprises a speed limit change, a perceived change in road safety, road conditions, or any combination thereof.

The vehicle route system of any of the previous clauses, wherein the processor is further configured to: obtain additional information from one or more additional data sources to supplement its classification of the one or more changes, the additional information from the one or more additional data sources comprising web scraping data related to the physical infrastructure category; and update, based on the additional information, the confidence value.

The vehicle route system of any of the previous clauses, wherein the processor is further configured to: display, on a map, including the first vehicle route and the second vehicle route; and update the map to display the one or more changes.

The vehicle route system of any of the previous clauses, wherein the processor is further configured to: aggregate the one or more changes for a plurality of vehicles for a plurality of destinations over a predetermined time period; classify whether the aggregated one or more changes fall into the first category or a second category selected from the plurality of categories; and display the location of the aggregated one or more changes on a map relative to the first vehicle route.

The vehicle route system of any of the previous clauses, wherein the processor is further configured to: determine the one or more changes by comparing road network links to historic map data, the one or more changes including changes in vehicle driving patterns; and assign one or more rankings to a respective region on a map based on the one or more changes.

A method, comprising: obtaining a first vehicle route for a vehicle, the first vehicle route comprising a predetermined route to a destination by the vehicle; comparing a second vehicle route undertaken by the vehicle with the first vehicle route; determining, based on the comparison, one or more changes between the first vehicle route and the second vehicle route, the one or more changes including a vehicle maneuver on the second vehicle route that deviates from a road segment along the first vehicle route; classifying whether the one or more changes fall into a first category selected from a plurality of categories, the first category comprising a physical infrastructure category; and determining a confidence value based on the classification of the one or more changes.

The method of the previous clause, wherein the physical infrastructure category comprises a bridge, a ramp, a link, a lane, or any combination thereof.

The method of any of the previous clauses, further comprising classifying whether the one or more changes fall into a second category selected from a plurality of categories, the second category comprising a non-physical infrastructure category.

The method of any of the previous clauses, wherein the non-physical infrastructure category comprises a speed limit change, a perceived change in road safety, road conditions, or any combination thereof.

The method of any of the previous clauses, further comprising: obtaining additional information from one or more additional data sources to supplement its classification of the one or more changes, the additional information from the one or more additional data sources comprising web scraping data related to the physical infrastructure category; and updating, based on the additional information, the confidence value.

The method of any of the previous clauses, further comprising: displaying, on a map, including the first vehicle route and the second vehicle route; and updating the map to display the one or more changes.

The method of any of the previous clauses, further comprising: aggregating the one or more changes for a plurality of vehicles for a plurality of destinations over a predetermined time period; classifying whether the aggregated one or more changes fall into the first category or a second category selected from the plurality of categories; and displaying the location of the aggregated one or more changes on a map relative to the first vehicle route.

The method of any of the previous clauses, further comprising: determining the one or more changes by comparing road network links to historic map data, the one or more changes including changes in vehicle driving patterns; and assigning one or more rankings to a respective region on a map based on the one or more changes.

A non-transitory computer-readable medium comprising instructions that, when executed by at least one processor, cause the at least one processor to perform one or more operations comprising: obtaining a first vehicle route for a vehicle, the first vehicle route comprising a predetermined route to a destination by the vehicle; comparing a second vehicle route undertaken by the vehicle with the first vehicle route; determining, based on the comparison, one or more changes between the first vehicle route and the second vehicle route, the one or more changes including a vehicle maneuver on the second vehicle route that deviates from a road segment along the first vehicle route; classifying whether the one or more changes fall into a first category selected from a plurality of categories, the first category comprising a physical infrastructure category; and determining a confidence value based on the classification of the one or more changes.

The non-transitory computer-readable medium of any of the previous clauses, the one or more operations further comprising: obtaining additional information from one or more additional data sources to supplement its classification of the one or more changes, the additional information from the one or more additional data sources comprising web scraping data related to the physical infrastructure category; and updating, based on the additional information, the confidence value.

The non-transitory computer-readable medium of any of the previous clauses, the one or more operations further comprising: determining the one or more changes by comparing road network links to historic map data, the one or more changes including changes in vehicle driving patterns; and assigning one or more rankings to a respective region on a map based on the one or more changes.

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some aspects may be combined in some other aspects. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein include one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A vehicle route system, comprising:
a processor; and
a non-transitory, processor-readable storage medium communicatively coupled to the processor, the non-transitory, processor-readable storage medium comprising one or more instructions stored thereon that, when executed, cause the processor to:
obtain a first vehicle route for a vehicle, the first vehicle route comprising a predetermined route to a destination by the vehicle;
compare a second vehicle route undertaken by the vehicle with the first vehicle route;
determine, based on the comparison, one or more changes between the first vehicle route and the second vehicle route, the one or more changes including a vehicle maneuver on the second vehicle route that deviates from a road segment along the first vehicle route;
classify whether the one or more changes fall into a first category selected from a plurality of categories, the first category comprising a physical infrastructure category; and
determine a confidence value based on the classification of the one or more changes.

2. The vehicle route system of claim 1, wherein the physical infrastructure category comprises a bridge, a ramp, a link, a lane, or any combination thereof.

3. The vehicle route system of claim 1, wherein the processor is further configured to classify whether the one or more changes fall into a second category selected from a plurality of categories, the second category comprising a non-physical infrastructure category.

4. The vehicle route system of claim 3, wherein the non-physical infrastructure category comprises a speed limit change, a perceived change in road safety, road conditions, or any combination thereof.

5. The vehicle route system of claim 1, wherein the processor is further configured to:
obtain additional information from one or more additional data sources to supplement its classification of the one or more changes, the additional information from the one or more additional data sources comprising web scraping data related to the physical infrastructure category; and
update, based on the additional information, the confidence value.

6. The vehicle route system of claim 1, wherein the processor is further configured to:
display, on a map, including the first vehicle route and the second vehicle route; and
update the map to display the one or more changes.

7. The vehicle route system of claim 1, wherein the processor is further configured to:
aggregate the one or more changes for a plurality of vehicles for a plurality of destinations over a predetermined time period;
classify whether the aggregated one or more changes fall into the first category or a second category selected from the plurality of categories; and
display the location of the aggregated one or more changes on a map relative to the first vehicle route.

8. The vehicle route system of claim 1, wherein the processor is further configured to:
determine the one or more changes by comparing road network links to historic map data, the one or more changes including changes in vehicle driving patterns; and
assign one or more rankings to a respective region on a map based on the one or more changes.

9. A method, comprising:
obtaining a first vehicle route for a vehicle, the first vehicle route comprising a predetermined route to a destination by the vehicle;
comparing a second vehicle route undertaken by the vehicle with the first vehicle route;
determining, based on the comparison, one or more changes between the first vehicle route and the second vehicle route, the one or more changes including a vehicle maneuver on the second vehicle route that deviates from a road segment along the first vehicle route;
classifying whether the one or more changes fall into a first category selected from a plurality of categories, the first category comprising a physical infrastructure category; and
determining a confidence value based on the classification of the one or more changes.

10. The method of claim 9, wherein the physical infrastructure category comprises a bridge, a ramp, a link, a lane, or any combination thereof.

11. The method of claim 9, further comprising classifying whether the one or more changes fall into a second category selected from a plurality of categories, the second category comprising a non-physical infrastructure category.

12. The method of claim 11, wherein the non-physical infrastructure category comprises a speed limit change, a perceived change in road safety, road conditions, or any combination thereof.

13. The method of claim 9, further comprising:
obtaining additional information from one or more additional data sources to supplement its classification of the one or more changes, the additional information from the one or more additional data sources comprising web scraping data related to the physical infrastructure category; and
updating, based on the additional information, the confidence value.

14. The method of claim 9, further comprising:
displaying, on a map, including the first vehicle route and the second vehicle route; and
updating the map to display the one or more changes.

15. The method of claim 9, further comprising:
aggregating the one or more changes for a plurality of vehicles for a plurality of destinations over a predetermined time period;
classifying whether the aggregated one or more changes fall into the first category or a second category selected from the plurality of categories; and
displaying the location of the aggregated one or more changes on a map relative to the first vehicle route.

16. The method of claim 9, further comprising:
determining the one or more changes by comparing road network links to historic map data, the one or more changes including changes in vehicle driving patterns; and
assigning one or more rankings to a respective region on a map based on the one or more changes.

17. A non-transitory computer-readable medium comprising instructions that, when executed by at least one processor, cause the at least one processor to perform one or more operations comprising:
obtaining a first vehicle route for a vehicle, the first vehicle route comprising a predetermined route to a destination by the vehicle;
comparing a second vehicle route undertaken by the vehicle with the first vehicle route;
determining, based on the comparison, one or more changes between the first vehicle route and the second vehicle route, the one or more changes including a vehicle maneuver on the second vehicle route that deviates from a road segment along the first vehicle route;
classifying whether the one or more changes fall into a first category selected from a plurality of categories, the first category comprising a physical infrastructure category; and
determining a confidence value based on the classification of the one or more changes.

18. The non-transitory computer-readable medium of claim 17, the one or more operations further comprising:
obtaining additional information from one or more additional data sources to supplement its classification of the one or more changes, the additional information from the one or more additional data sources comprising web scraping data related to the physical infrastructure category; and
updating, based on the additional information, the confidence value.

19. The non-transitory computer-readable medium of claim 17, the one or more operations further comprising:
aggregating the one or more changes for a plurality of vehicles for a plurality of destinations over a predetermined time period;
classifying whether the aggregated one or more changes fall into the first category or a second category selected from the plurality of categories; and
displaying the location of the aggregated one or more changes on a map relative to the first vehicle route.

20. The non-transitory computer-readable medium of claim 17, the one or more operations further comprising:
determining the one or more changes by comparing road network links to historic map data, the one or more changes including changes in vehicle driving patterns; and
assigning one or more rankings to a respective region on a map based on the one or more changes.
